(19) United States
(12) Patent Application Publication
(10) Pub. No.: US 2007/0054072 A1
(43) Pub. Date: Mar. 8, 2007

(54) Packaging material for a developing agent cartridge

(75) Inventors: Peter Wallace Bracken, Lexington, KY (US); James Eric Dickerson, Lexington, KY (US); Mark Duane Foster, Lexington, KY (US); Johnny Dale Massie II, Lexington, KY (US); Robert Watson McAlpine, Lexington, KY (US); Donald Wayne Stafford, Georgetown, KY (US); Gregory Scott Tigges, Frankfort, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/222,007

(22) Filed: Sep. 8, 2005

(51) Int. Cl. B32B 27/32

(52) U.S. Cl. 428/35.2; 428/36.1

(57) ABSTRACT

The present invention relates to packaging materials that may be used for components in an image forming apparatus. The packaging material may include polymeric fiber which may be in the form of a non-woven, woven or knit fabric. The fiber may contain less than 5.0% of compounds having molecular weights of equal to or less than about 2500. The packaging material may also absorb developing agent.

### FIELD OF INVENTION

The present invention relates to a packaging material for a developing agent cartridge. The cartridge may be included in an image forming apparatus. An image forming apparatus may include electrophotographic printers or inkjet printers, copiers, faxes, all-in-one devices and multi-function devices.

### BACKGROUND

In an image forming apparatus, developing agent, such as toner, ink or other image forming substance, may be used to create or develop images on media. As images are formed, the developing agent, as well as other image forming components, such as the developer, photoconductor, charge device, transfer device, etc., may become exhausted. Accordingly, the developing agent and/or other components may need replacement. For this purpose, there may be provided a new developing agent cartridge, which may contain the developing agent, and/or a number of image forming components to replace the exhausted or otherwise damaged components.

To provide a developing agent cartridge and/or other components it may be necessary to ship and store the cartridge and/or other components prior to use by the consumer. Various packaging materials may be required to protect the developing agent cartridge. Furthermore, it may be necessary to supply a packaging material that prevents the leakage of the developing agent from the packaging.

### SUMMARY

An exemplary embodiment of the present invention relates to the use of polymeric fiber material for a developing agent cartridge. The fiber material may be in the form of a non-woven fabric. The packaging material may have less than about 5.0% wt. of compounds having molecular weights of less than or equal to about 2500. The packaging material may also be capable of absorbing developing agent. The packaging material may also include the use of polymer film material. The packaging material may be formed into a pouch or bag for the cartridge. The packaging material may also be positioned within a container to provide a region of fabric that may be capable of releaseably contacting the cartridge.

### DETAILED DESCRIPTION

The present invention relates to the use of polymeric fiber material as a packaging material for a developing agent cartridge. Accordingly, suitable and non-limiting examples of such fiber material may include cellulosics, polyolefins, acrylics, polyesters, polyamides, etc.

With regard to the exemplary and non-limiting use of cellulosic or viscose fibers, such fibers may include rayon. Cellulosic fiber may therefore be a manufactured fiber composed of regenerated cellulose, in which substituents may replace no more than 15% of the hydrogens of the hydroxyl groups. The polyolefin fibers that may be employed may include polypropylene and/or polyethylene. The polyolefin fiber may be a manufactured fiber in which the fiber forming substance may be any long-chain synthetic polymer composed of at least 85% by weight of ethylene, propylene, or other olefin units.

Acrylic fibers also serve as a fiber for use as a cartridge packaging material. Acrylic fiber may be a manufactured fiber in which the fiber forming substance is any long-chain synthetic polymer composed of at least 85% by weight of acrylonitrile units. Polyester fibers may also be utilized and may include, for example, polyethylene terephthalate (PET) or polyethylene naphthalate (PEN). The polyester fibers may be a manufactured fiber in which the fiber forming substance is any long-chain synthetic polymer composed of at least 85% by weight of an ester of a substituted aromatic carboxylic acid, including but not limited to substituted terephthalic units and parasubstituted hydroxyl-benzoate units.

The packaging material may be in the form of a non-woven, woven or knit fabric. This may therefore include a single layer of fabric or multiple layers of fabric. Each layer may be composed of a different or similar polymer material or a blend of polymer materials. The fabric may be made from a web of fiber by mechanical interlocking in a web or mat, fusing the fibers together or by bonding the fibers together. For example, the webs may be hydroentangled, carded, spunlaced, needlepunched, stitched or fused by processes such as coating, calendaring or ultrasonic welding. The fibers may also be oriented in one or more directions or randomly placed. The fabric may also be made from fibers formed into yarns or filaments that may be woven or have rows of loops that interlock with the following row. If more than one layer is present, the layers may then be bonded together using the techniques described above.

The fabric may also include a binder to help fuse the fibers in individual layers or fuse multiple layers together. The binder may be present in the form of fibers or a coating. Binder fibers may include one or a plurality of polymer components and may be in the form of a sheath/core, side by side or monofilament configuration. Alternatively, the binder may be coated on the fabric using a number of coating methods. For example, the binder may be saturation bonded, gravure coated, spray bonded, etc. Furthermore, bonding may occur over the entire surface of the fabric or over selected portions of the fabric to form desired patterns. The binder may be a polymeric material such as acrylic or rubber latex.

The packaging material may contact the developing agent cartridge and/or other components. Therefore, it has been found useful to reduce the presence of those compounds that would otherwise migrate from the cartridge packaging material and which may be problematically absorbed by components within the cartridge. Such compounds which may be capable of migration include, but are not limited to relatively low molecular weight solvents, plasticizers, monomers and/or oligomers. For example, such compounds may include phthalate based plasticizers, such as dioctyl phthalate (DOP) which has a molecular weight of about 390. Accordingly, those compounds which may otherwise volatilize and migrate from the packaging material, with respect to molecular weight considerations, may now be reduced. In addition, by controlling the presence of such compounds, electrophotographic components, such as toner, photoconductors, developer roller, toner adder rollers, etc., may be more efficiently shielded from the potential of chemical contamination. In addition, via use of the packaging material herein it may also become unnecessary to separately ship such components when, e.g., a toner cartridge is completely replaced.

Accordingly, the fabric may contain less than 5.0% (wt.) of compounds having molecular weights of equal to or less than about 2500, including levels between 0.01% to 5% wt. and all incremental values and ranges therebetween. For example, in the present invention the levels of such compounds may be controlled to be equal to or less than 1.0% (wt.), 2.0% (wt.) etc., or they may be present at levels between 0.1-5.0% (wt.). In addition, the compounds, as noted, may have molecular weights equal to or less than 2500, as well as any molecular weights between 50-2500, including all values and increments therebetween. For example, molecular weights equal to or less than 2400, 2300, 2200, etc. In such regard, it may be appreciated that control of molecular weight in such fashion may correspond to a control of the presence of compound vapor pressure, volatility, sublimation potential, diffusion and/or overall migration capability.

In accordance with the above feature of optionally controlling the above mentioned characteristics of those compounds within the fabric, an exemplary and non-limiting example includes a polyester-rayon non-woven fabric coated with an acrylic to bond the polyester and rayon. Such material is available as “ISB1601” from Precision Custom Coatings, Inc.

The packaging material may be formed into a number of shapes to accommodate the developing agent cartridge as well as any other replaceable component within the image forming device. For example, the packaging material may be formed into the shape of a blanket, bonnet, pouch, or bag. These shapes may be formed by stitching, thermal bonding or ultrasonic bonding of the fabric. The packaging material may also include the use of polymeric film. The polymeric film may be a layer of polyolefin polymer. The polymeric film may also surround a portion or the entirety of the fabric and therefore similarly exists in the form of a pouch or bag for the cartridge. The film may also be laminated to the fabric to provide a composite packaging material.

Furthermore, one may also supply a container for the developing agent cartridge, where the container includes a region of fabric packaging material. The packaging material may then be configured so that it may releasably contact the cartridge. When the cartridge is then removed from the container, the fabric may release from the cartridge and remain within the container, so that the user is not required to separately remove the fabric from the cartridge prior to use. The containers may be made from materials such as cardboard or plastic.

The foregoing description is provided to illustrate and explain the present invention. However, the description hereinabove should not be considered to limit the scope of the invention set forth in the claims appended here to.

What is claimed is:

1. A packaging material for a developing agent cartridge within an image forming apparatus, said packing material comprising polymeric fiber material.

2. The packaging material of claim 1 wherein said polymeric fiber material comprises a non-woven fabric.

3. The packaging material of claim 1 wherein said polymeric fiber material is capable of absorbing image forming material.

4. The packaging material of claim 1 wherein said polymeric fiber is selected from the group consisting of polyester, cellulosic polymers, polypropylene, acrylic, polyolefins and combinations thereof.

5. The packaging material of claim 1 wherein said polymer material contains less than about 5.0% wt. of compounds having molecular weights of equal to or less than about 2500.

6. The packaging material of claim 5 wherein said compounds comprise phthalate compounds.

7. The packaging material of claim 5 wherein said compounds are present at about or less than 1.0% wt.

8. The packaging material of claim 2 wherein said non-woven fabric material includes a binder resin.

9. The packaging material of claim 1 wherein said polymeric fiber material forms a first packaging layer and further including a second packaging layer of polymer film material.

10. The packaging material of claim 9 wherein said polymer film material comprises a polyolefin polymer.

11. A storage pouch for covering all or a portion of a developing agent cartridge within an image forming apparatus, said storage pouch comprising a polymeric fiber material.

12. The storage pouch of claim 11 wherein said polymeric fiber material comprises a non-woven fabric.

13. The storage pouch of claim 11 wherein said polymer material is capable of absorbing developing agent.

14. The storage pouch of claim 13 wherein said polymer fibers are selected from the group consisting of polyester, cellulosic polymers, polypropylene, acrylic, polyolefins and combinations thereof.

15. The storage pouch of claim 11 wherein said polymer material contains less than about 5.0% wt. of compounds having molecular weights of less than or equal to about 2500.

16. The storage pouch of claim 15 wherein said compounds comprise phthalate compounds.

17. The storage pouch of claim 15 wherein said compounds are present at about or less than 1.0% wt.

18. The storage pouch of claim 12 wherein said non-woven polymer material includes a binder resin.

19. The storage pouch of claim 11 further including a layer of polymer film material for covering all or a portion of said pouch.

20. The storage pouch of claim 19 wherein said polymer film material comprises a polyolefin polymer.

21. A container for a developing agent cartridge, said container comprising a region of polymeric fiber material capable of releasably contacting said cartridge and capable of absorbing developing agent stored in said cartridge.

22. The container of claim 21 wherein said polymeric fiber material contains less than about 5.0% wt. of compounds having a molecular weight of equal to or less than about 2500.
